(19) United States
(12) Patent Application Publication
(10) Pub. No.: US 2011/0145871 A1
(43) Pub. Date: Jun. 16, 2011

(54) SYSTEM AND METHOD OF PROVIDING EFFICIENT VIDEO-ON-DEMAND SERVICE USING UNICAST/MULTICAST IN INTERNET PROTOCOL NETWORK

(75) Inventors: Jong Min Lee, Daejeon (KR); Hyojin Park, Daejeon (KR); Jun Kyun Choi, Daejeon (KR)

(73) Assignee: KOREA ADVANCED INSTITUTE OF SCIENCE AND TECHNOLOGY, Daejeon (KR)

(21) Appl. No.: 12/704,610

(22) Filed: Feb. 12, 2010

(30) Foreign Application Priority Data
Dec. 14, 2009 (KR) 10-2009-0123979

(51) Int. Cl. H04N 7/173

(52) U.S. Cl. 725/98

(57) ABSTRACT

A system and method for providing an efficient video-on-demand (VoD) service using unicast/multicast in an Internet Protocol (IP) network are provided. A VoD service system includes a multicast efficiency factor (MEF) checking unit to check an MEF in content in response to a request for the content from a client, and a content transmission unit to multicast or unicast the content over a network depending on the checked MEF. Here, the MEF includes an indicator of efficiency for multicast transmission relative to unicast transmission of the content.

### CROSS-REFERENCE TO RELATED APPLICATION

This application claims the benefit of Korean Patent Application No. 10-2009-0123979, filed on Dec. 14, 2009, in the Korean Intellectual Property Office, the disclosure of which is incorporated herein by reference.

### BACKGROUND

1. Field of the Invention

The present invention relates to a system and method of providing an efficient video-on-demand (VoD) service using unicast/multicast in an Internet Protocol (IP) network.

2. Description of the Related Art

Currently, a VoD service is provided in a unicast mode in response to user's request. It is easy to implement a unicast scheme, however problems in efficiency may occur due to an increase in users. To provide such a VoD service to overcome these problems, various wired/wireless communication technologies are employed, and in particular, multicasting technologies are being introduced. Most of these technologies are based on IP multicast. IP multicast enables multiple users to share resources using the same group ID (for example, a multicast group address), so that they may receive the same multimedia data. Thus, IP multicast can advantageously increase resource efficiency.

Accordingly, there is a demand for a VoD service system and method for efficiently providing a VoD service in an IP network.

### SUMMARY

An aspect of the present invention provides a video-on-demand (VoD) service system and method to allocate channels through simple binding of parameters when a new connection and a change are required to provide various broadcast services such as a VoD service.

Another aspect of the present invention also provides a VoD service system and method to more efficiently provide a VoD service by appropriately dividing connection management techniques between servers and user terminals over an Internet network into a multicast scheme or a unicast scheme.

Still another aspect of the present invention also provides a VoD service system and method to select one of multi-channel multicasting or unicasting using VoD service channels classified based on a user request rate, to provide a greater number of users with a VoD service within a limited system capacity.

According to an aspect of the present invention, there is provided a VoD service system including a multicast efficiency factor (MEF) checking unit to check an MEF in content in response to a request for the content from a client, and a content transmission unit to multicast or unicast the content over a network depending on the checked MEF. Here, the MEF may include an indicator of efficiency for multicast transmission relative to unicast transmission of the content.

The MEF may be determined based on a request rate, a length of a time unit, and a start-up delay time with respect to the content.

The content transmission unit may include a multicast unit to multicast the content when the MEF is equal to or greater than a predetermined value, and a unicast unit to unicast the content when the MEF is less than the predetermined value.

The multicast unit may include a content division unit to divide the content into a plurality of segments to implement a multi-channel multicast, and a transmitter to map the plurality of segments to a multicast classifier and to multicast the content.

A number of channels required for the multi-channel multicast may be determined based on a length of a total time unit and a VoD service start-up delay time, and a number of the segments may be determined based on the determined number of channels.

The VoD service system may further include a multicasting determination unit to determine whether the content is currently multicast, and a multicast group address transmitter to transmit a multicast group address to the client when the content is determined to be currently multicast or when the content transmission unit multicasts the content.

The MEF checking unit may check the MEF when the content is determined not to be currently multicast.

According to another aspect of the present invention, there is provided a VoD service in a VoD service method including checking an MEF in a content in response to a request for the content from a client, and multicasting or unicasting the content over a network depending on the checked MEF. Here, the MEF may include an indicator of efficiency for multicast transmission relative to unicast transmission of the content.

### EFFECT

According to an embodiment of the present invention, it is possible to allocate channels through simple binding of parameters when a new connection and a change are required to provide various broadcast services such as a VoD service. It is also possible to more efficiently provide a VoD service by appropriately dividing connection management techniques between servers and user terminals over an Internet network into a multicast scheme or a unicast scheme.

Additionally, according to an embodiment of the present invention, it is possible to select one of multi-channel multicasting or unicasting using VoD service channels classified based on a user request rate, in order to provide a greater number of users with a VoD service within a limited system capacity.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a transmission method when a fast broadcasting (FB) scheme is used in a related art;

FIG. 2 illustrates a transmission method when a pyramid broadcasting (PB) scheme is used in a related art;

FIG. 3 illustrates a transmission method when a reverse fast broadcasting (RFB) scheme is used in a related art;

FIG. 4 illustrates a VoD broadcast service network apparatus according to an exemplary embodiment of the present invention;

FIG. 5 is a flowchart illustrating a VoD broadcast service method in a VoD service system according to an exemplary embodiment of the present invention;

FIG. 6 is a block diagram illustrating an inner configuration of a VoD service system according to an exemplary embodiment of the present invention;

FIG. 7 is a flowchart illustrating a VoD service method according to an exemplary embodiment of the present invention; and

FIG. 8 is a graph illustrating performance of a VoD service system according to an exemplary embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Exemplary embodiments of the present invention relate to service procedures for an efficient video-on-demand (VoD) service in an Internet Protocol (IP) network, a method for transmitting a packet between user terminals, also referred to as clients, for example a method for combining a multi-channel multicast scheme and a unicast scheme, and an apparatus thereof. Hereinafter, description will be made of a resource allocation technique for efficiently providing a VoD service in the IP network, of a technique for allocating connection identifications (IDs) (for example, port numbers or session IDs) to transmit packets in hybrid multicast-unicast mode, and of transmission processes suitable for these techniques. In the resource allocation technique for the VoD service, VoD content with a high request rate is transmitted in a multi-channel multicast mode, and other VoD content with a low request rate is transmitted in a unicast mode. Herein, whether to perform multi-channel multicasting or unicasting may be determined based on a multicast efficiency factor (MEF) as described below. A VoD service system corresponding to a VoD server may map an access to a multicast/unicast connection ID (for example, a multicast/unicast IP address, a port number, a session ID or a port), and may transmit the mapped access. Thus, it is possible to increase efficiency of a bandwidth required for the VoD service and to reduce a probability of blocking the VoD service, thereby providing a great number of users with the VoD service.

1. Multi-Channel Multicasting in Server

In order to transfer multicast VoD content as though unicast transmission is transmitted and to satisfy a start-up delay requirement, content may be chopped. In accordance with Telecommunication Standardization Sector (ITU-T) Recommendation G.1010, a start-up delay time for VoD content is less than about 10 seconds. Accordingly, in the VoD service system according to the exemplary embodiment of the present invention, the maximum start-up delay time may be less than about 10 seconds. In this instance, assuming that there is ‘i’-th VoD content with length ‘Lᵢ,’ the number of channels, which are required for ‘i’-th video and have length ‘Lᵢ’ to meet the requirement for the start-up delay time (‘sd’<10 seconds) during multi-channel multicasting, may be determined by the following Equation 1:

$${n}_{i} = ⌈ {Log}_{2} ( \frac{{L}_{i}}{sd} + 1 ) ⌉ , \qquad [ Equation 1 ]$$

where ‘nᵢ’ denotes the number of required channels, denotes the length of content such as video, and ‘sd’ denotes the start-up delay time, as described above. In this instance, start-up delay time ‘sd’ required for VoD service may be less than about 10 seconds according to the ITU-T Recommendation G.1010.

Equation 1 is derived from fast broadcasting (FB), and is modified to adopt the minimum start-up delay requirement. After calculating the number of channels, a chopper may equally divide content into ‘N’ segments using Equation 2 below. Herein, an equation for calculating the number of required channels may be determined according to the above-described transmission schemes (for example, FB, pyramid broadcasting (PB), or reverse FB (RFB)).

$$N = {\sum }_{j = 0}^{{n}_{i}} {2}^{j} = {2}^{{n}_{i}} - 1. \qquad [ Equation 2 ]$$

In a multimedia server, a session manager may allocate segments to proper channels, so that the segments may be streamed consecutively and periodically to the channels by geometric progression of 1, 2, 4, . . . , ‘N.’ Two examples of the number of sessions required for multi-channel multicasting are shown in Table 1 below. For example, if user created content (UCC) has a length of about 5 minutes, six channels may only be used to process UCC requests without any limitation. Table 1 shows examples of the number of required channels.

TABLE 1

| | Number of channels | Maximum start-up |
|---|---|---|
| Video length (Lᵢ) | required (nᵢ) | delay (sd) |
| 2700 sec (45 min) | 8 | 5.3 sec. |
| 300 sec (5 min) | 6 | 4.7 sec. |

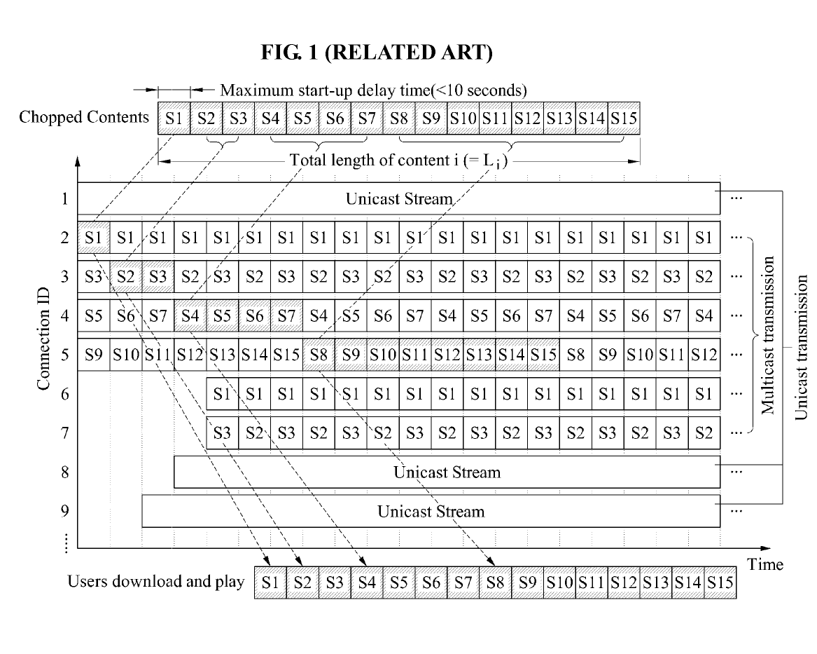

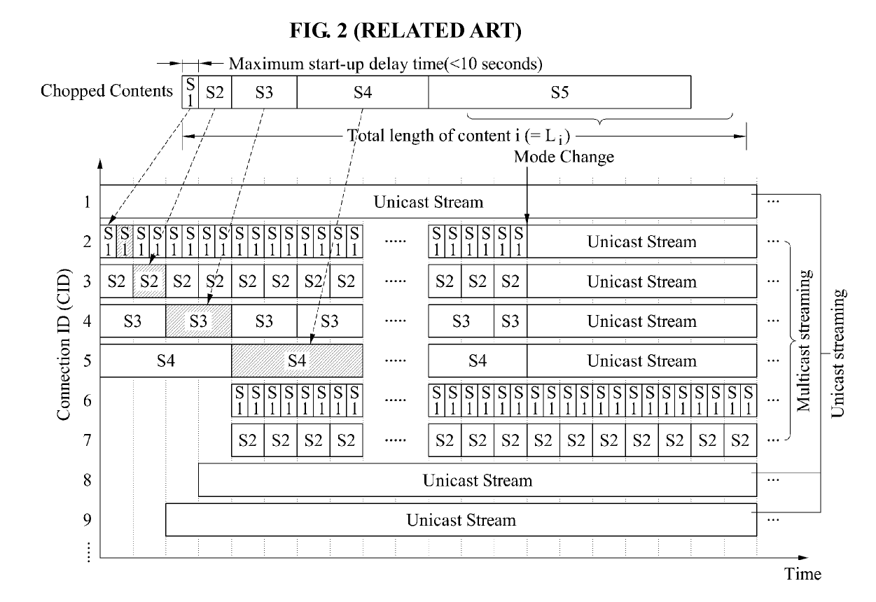

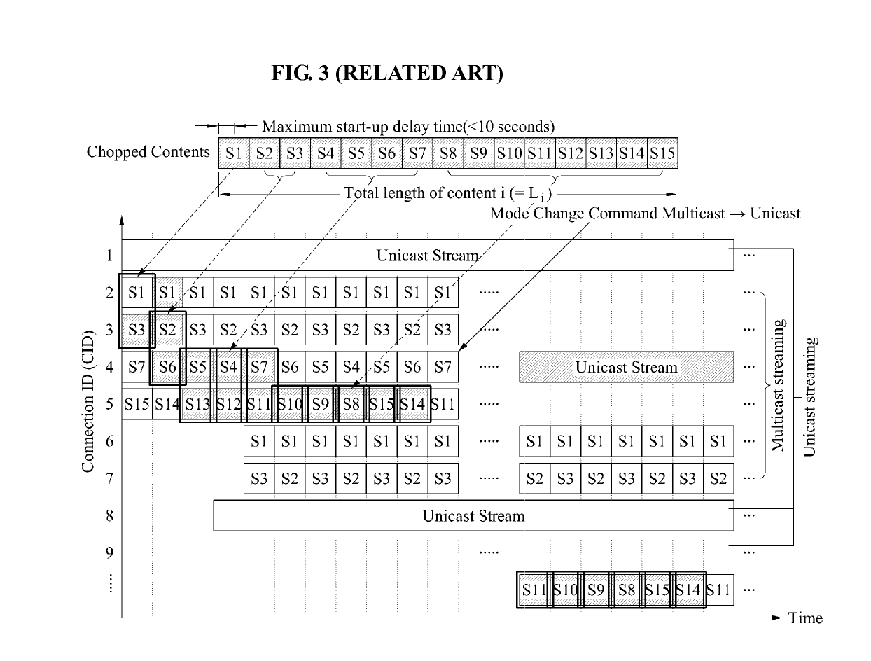

FIGS. 1 to 3 illustrate various transmission methods performed when an FB scheme, a PB scheme and a RFB scheme are used, respectively, in a related art. In addition to the transmission methods shown in FIGS. 1 to 3, various near-VoD (N-VoD) or broadcasting schemes may be used, for example a staggered broadcasting scheme, a skyscraper broadcasting scheme, a pagoda broadcasting scheme, and a harmonic broadcasting scheme. Exemplary embodiments are provided to describe determining whether to transmit content in multi-channel multicast mode or unicast mode, not to describe the above transmission methods, and thus, further description of transmission methods are omitted herein.

2. Determination of Whether to Perform Multi-Channel Multicasting or Unicasting

Herein, for convenience of description, a group of ‘K’ videos, namely ‘V₁’ to ‘V_{K},’ is considered. Videos ‘V₁’ to ‘V_{K}’ have length and request rates ‘λ₁,’ . . . , ‘λₖ,’ respectively, and are transmitted through ‘C’ channels. In addition, ‘λᵢ’ is assumed to be greater than ‘λⱼ,’ with respect to integers ‘i’ and ‘j’ (1≧i>j≧K). For example, a video request rate, namely video popularity, may decrease gradually as an index increases, so that video ‘V₁’ and video ‘V_{K}’ are assumed to be the most popular content and the least popular content, respectively. Here, content popularity may be determined according to the number of user's requests for the content. In other words, video with a higher request rate may be regarded as a relatively more popular video. Additionally, the content popularity or request frequency ranking may be calculated and given by a service provider based on statistical data and a service policy. In a hybrid transmission system according to an exemplary embodiment, content may be classified into two types, for example a unicast type and a multicast type. Content may be transmitted using different methods, which may be decided by an MEF. The MEF may refer to an efficiency indicator of multicast transmission compared to unicast transmission. For example, if an MEF is 1, unicasting and multicasting of the same content may have the same efficiency. However, if an MEF is greater than 1, multicast transmission may be more efficient than unicast transmission.

As described above, in the hybrid transmission system, content may be classified into two groups by two transmission schemes, unicast and multicast, and the MEF may be calculated according to the request rate and length of content. Such an MEF may indicate how much more efficient multicast is over unicast for transmission in terms of channel consumption. Specifically, an MEF with a value of 1 means that the number of channels required for unicasting content is equal to the number of channels required for multicasting the same content. Therefore, unicasting the content may be more desirable when an MEF is less than 1 since multicast the content is less efficient. Additionally, when an MEF is greater than 1, multicast transmission may be more efficient than unicast transmission. This MEF may be calculated using the following Equation 3:

$${MEF}_{i} = \frac{{λ}_{i}}{⌈ {Log}_{2} ( \frac{{L}_{i}}{sd} + 1 ) ⌉ \cdot {μ}_{i}} , \qquad [ Equation 3 ]$$

where ‘MEFᵢ’ denotes an MEF of ‘i’-th content, and ‘μᵢ’ is the reciprocal of a length of the T-th content and denotes a service rate of the ‘i’-th content.

Table 2 shows several examples of the number of required channels and an MEF according to the request rate and length of content.

TABLE 2

| | | Content | | Multicast |
|---|---|---|---|---|
| Content | Request | length | Required | efficiency |
| name | rate | (second) | channel | factor |
| (Vi) | (λᵢ) | (Li) | (ni) | (MEFi) |
| V1 | 0.02 | 1783 | 1 | 5.95 |
| V2 | 0.014 | 2274 | 8 | 4.0 |
| V3 | 0.01 | 242 | 5 | 0.5 |
| V4 | 0.008 | 1646 | 7 | 2.0 |
| V5 | 0.006 | 782 | 6 | 0.82 |

In Table 2, content ‘V1’ has a length of about 1783 seconds, and thus content ‘V1’ may be unicast for about 1783 seconds. Specifically, since a request rate of content ‘V1’ is 0.02, an average of 35.66 unicast connections may be used. However, only seven channels may be used in multi-channel multicasting, and thus multicasting may be 5.95 times more efficient than unicasting.

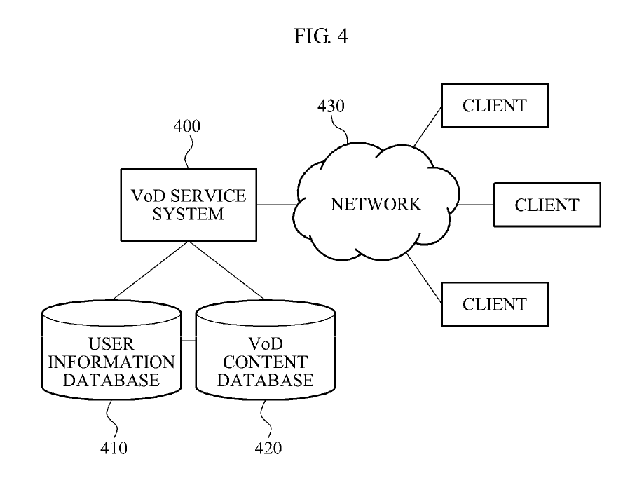

FIG. 4 briefly illustrates a VoD broadcast service network apparatus according to an exemplary embodiment. A VoD service system 400 of FIG. 4 may be implemented as a hybrid transmission system described above. As shown in FIG. 4, the VoD service system 400 may include a user information database 410 and a VoD content database 420, or may be connected to the user information database 410 and the VoD content database 420. Specifically, in response to requests for content from multiple clients connected over a network 430 such as an Internet network, the VoD service system 400 may authenticate the clients through the user information database 410. The VoD service system 400 may then search for VoD content requested by a client from the VoD content database 420, and may stream the VoD content found as a result of searching to the client so that the client may be provided with the VoD content. In this instance, the VoD service system 400 may perform multi-channel multicasting or unicasting of the requested VoD content depending on an MEF of the VoD content.

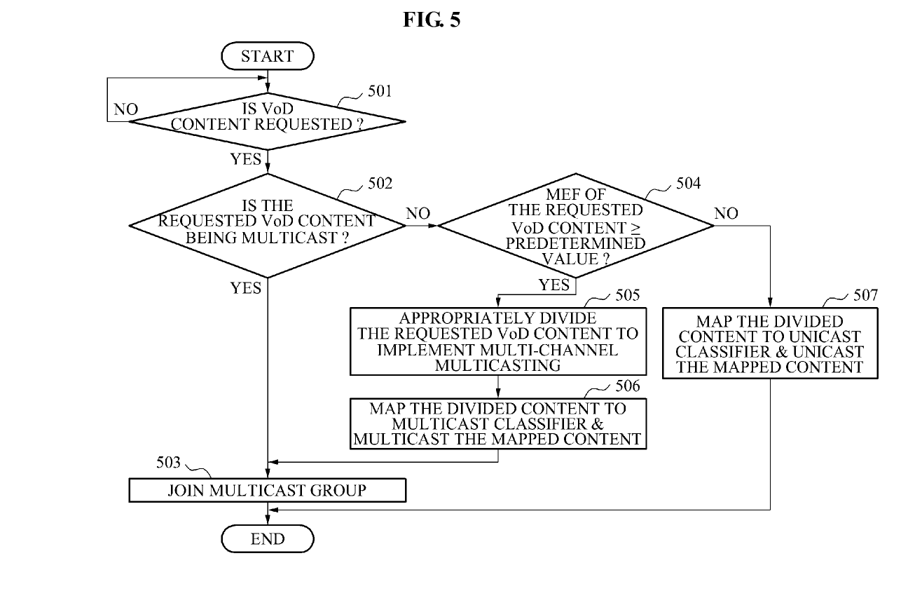

FIG. 5 is a flowchart illustrating a VoD broadcast service method in a VoD service system according to an exemplary embodiment of the present invention. The VoD broadcast service method of FIG. 5 may be performed by the VoD service system 400 described above with reference to FIG. 4.

The VoD service system 400 determines whether a VoD content request is received from a client in operation S501. The VoD service system 400 continues to perform operation S501 until VoD content is requested by the client. When the client requests VoD content, the VoD service system 400 may perform operation S502.

In operation S502, the VoD service system 400 determines whether the requested VoD content is currently being multicast. When determining that the requested VoD content is currently being multicast, the VoD service system 400 performs operation S503. Alternatively, when the content is determined not to be currently multicast, the VoD service system 400 performs operation S504.

In operation S503, the VoD service system 400 allows the client to join a multicast group. In this instance, the VoD service system 400 transmits an address for the multicast group to the client, so that the client may join the multicast group.

In operation S504, the VoD service system 400 determines whether an MEF of the requested VoD content is equal to or greater than a predetermined value. If the MEF is determined to be equal to or greater than the predetermined value, the VoD service system 400 performs operation S505. Alternatively, if the MEF is determined to be less than the predetermined value, the VoD service system 400 performs operation S507. Here, the MEF of the requested VoD content may be calculated using Equation 3 as described above.

In operation S505, the VoD service system 400 appropriately divides the requested VoD content to perform multi-channel multicasting. More specifically, the VoD service system 400 may divide the request VoD content into ‘N’ segments. In this instance, ‘N’ is an integer, and may be determined according to the number of required channels as shown in Equation 2.

In operation S506, the VoD service system 400 maps the divided content to a multicast classifier, and multicasts the mapped content. Here, the multicast classifier may be the ‘connection ID’ shown in FIGS. 1 to 3.

In operation S507, the VoD service system 400 maps the divided content to a unicast classifier, and unicasts the mapped content. Here, the unicast classifier may also be the ‘connection ID’ (for example, a multicast IP address, a session ID, a port number or the like), as shown in FIGS. 1 to 3. In other words, sessions may be distinguished by their respective ‘connection IDs’ (for example, a multicast IP address, a session ID, a port number or the like), and may be multicast transmission or unicast transmission.

As described above, the MEF is a value indicating efficiency for multicast transmission relative to unicast transmission with respect to the same content. When multicast transmission is more efficient than unicast transmission for each VoD content, VoD content may be multicast to a client, and thus it is possible to effectively utilize a bandwidth for the VoD broadcast service.

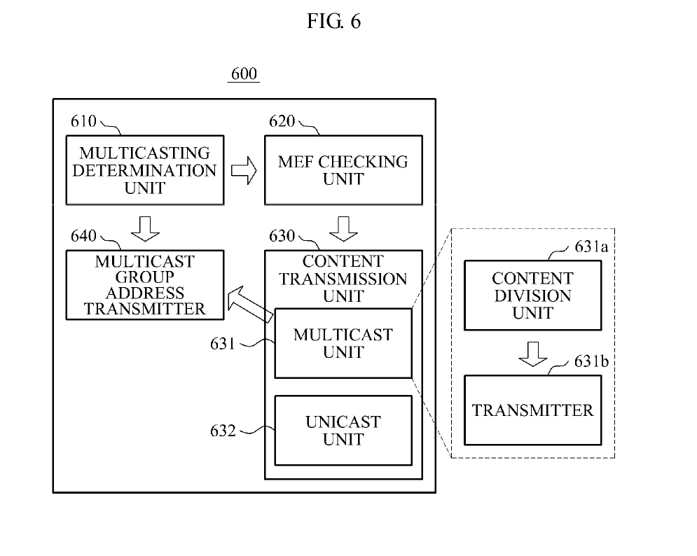

FIG. 6 is a block diagram illustrating an inner configuration of a VoD service system according to an exemplary embodiment of the present invention. In FIG. 6, a VoD service system 600 may be the hybrid transmission system described above or the VoD service system described with reference to FIGS. 4 and 5. The VoD service system 600 may include a multicasting determination unit 610, an MEF checking unit 620, a content transmission unit 630 and a multicast group address transmitter 640, as shown in FIG. 6.

The multicasting determination unit 610 determines whether content requested by a client is currently being multicast. Specifically, when the content is determined to be currently multicast, a multicast group address may be merely transferred to the client without further processing, so that the client may receive the content by multicast. Here, the multicast group address may be transmitted to the client by the multicast group address transmitter 640 that will be described below.

The MEF checking unit 620 checks an MEF of content in response to a request for the content from a client. Here, when the content is determined not to be currently multicast, the MEF checking unit 620 may check the MEF. Specifically, when the content is already being multicast, the VoD service system 600 may enable the client to receive the multicast content, rather than re-transmitting the content to the client via another channel. Thus, it is possible to efficiently use the bandwidth for the VoD service.

Herein, the MEF refers to an efficiency indicator of multicast transmission relative to unicast transmission for the content, and may be determined based on a request rate, a length of a time unit, and a start-up delay time with respect to the content. As an example, the MEF of the content may be determined by the above-described Equation 3.

The content transmission unit 630 multicasts or unicasts the content over a network depending on the checked MEF. Since the MEF indicates efficiency of multicast transmission compared to unicast transmission with respect to the same content, whether to multicast or unicast the content may be determined depending on the MEF. Additionally, the content transmission unit 630 may include a multicast unit 631 and a unicast unit 632, as shown in FIG. 6.

The multicast unit 631 multicasts the content when the MEF is equal to or greater than a predetermined value. For example, when the predetermined value is ‘1,’ and the MEF is equal to or greater than ‘1,’ the multicast unit 631 may multicast the content. Here, an MEF with a value equal to or greater than 1 means that multicast transmission is more efficient than unicast transmission, and thus the content transmission unit 630 may cause the multicast unit 631 to multicast the content.

Additionally, the multicast unit 631 may include a content division unit 631a to divide the content into a plurality of segments to implement a multi-channel multicast, and a transmitter 631b to map the plurality of segments to a multicast classifier and to multicast the content. In this instance, the number of channels required for multi-channel multicast may be determined based on the length of the time unit and the start-up delay time, and the number of the segments may be determined based on the number of channels. The content division unit 631a may be implemented by the chopper described above.

The unicast unit 632 unicasts the content when the MEF is less than the predetermined value. As described above, an MEF with a value less than 1 means that unicast transmission is more efficient than multicast transmission, and thus the content transmission unit 630 may cause the unicast unit 632 to unicast the content.

The multicast group address transmitter 640 transmits the multimedia group address to the client when the content is determined to be currently multicast or when the content transmission unit 630 multicasts the content. In more detail, the multicast group address transmitter 640 transmits to the client the multimedia group address for content being multicast by the content transmission unit 630, so that the client may join a multicast group corresponding to the multicast group address and may receive the content by multicast.

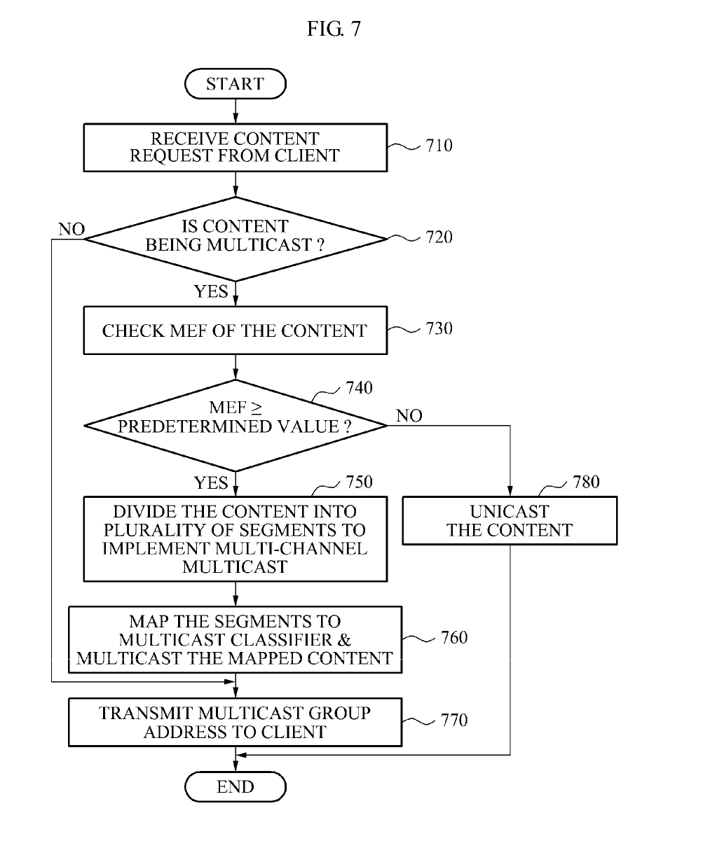

FIG. 7 is a flowchart illustrating a VoD service method according to an exemplary embodiment of the present invention. The VoD service method of FIG. 7 may be performed by the VoD service system 600 described above with reference to FIG. 6. Hereinafter, each operation of the VoD service method of FIG. 7 performed by the VoD service system 600 will be described.

In operation S710, the VoD service system 600 receives a content request from a client.

In operation S720, the VoD service system 600 determines whether content requested by the client is currently being multicast. In more detail, if the content is determined to be currently multicast, a multicast group address may be merely transferred to the client without further processing, so that the client may receive the content by multicast. Here, the multicast group address may be transmitted to the client in operation S770 that will be described below. In other words, the VoD service system 600 may perform operation S730 when the content is determined to be currently multicast, and may perform operation S770 when the content is determined not to be currently multicast.

In operation S730, the VoD service system 600 checks an MEF of the content. Here, only when the content is determined not to be currently multicast may the VoD service system 600 check the MEF. Specifically, if the content is determined to be already multicast, the VoD service system 600 may enable the client to receive the multicast content, rather than re-transmitting the content to the client via another channel. Thus, it is possible to efficiently use the bandwidth for the VoD service.

Herein, the MEF refers to an efficiency indicator of multicast transmission relative to unicast transmission for the content, and may be determined based on a request rate, a length of a time unit, and a start-up delay time with respect to the content. For example, the MEF of the content may be determined by the above-described Equation 3.

In operation S740, the VoD service system 600 determines whether the MEF is equal to or greater than a predetermined value. Here, the VoD service system 600 may perform operation S750 when the MEF is determined to be equal to or greater than the predetermined value, and may perform operation S780 when the MEF is determined to be less than the predetermined value.

The VoD service system 600 divides the content into a plurality of segments to implement multi-channel multicast in operation S750, and maps the plurality of segments to a multicast classifier and multicasts the content in operation S760. In this instance, the number of channels required for multi-channel multicast may be determined based on the length of the time unit and the start-up delay time, and the number of the segments may be determined based on the number of channels. The content division unit 631a may be implemented by the chopper described above.

In operation S770, the VoD service system 600 transmits the multimedia group address to the client. As described above, the VoD service system 600 transmits to the client the multimedia group address for the content being multicast, so that the client may join a multicast group corresponding to the multicast group address and may receive the content.

In operation S780, the VoD service system 600 unicasts the content. When the MEF is determined to be less than the predetermined value in operation S740, the VoD service system 600 transmits the content to the client by unicast.

As described above, in the VoD service system and method according to exemplary embodiments of the present invention, it is possible to allocate channels through simple binding of parameters when new connection and change are required to provide various broadcast services such as a VoD service, and is also possible to more efficiently provide a VoD service by appropriately dividing connection management techniques between servers and user terminals over an Internet network into a multicast scheme or a unicast scheme. Additionally, it is possible to select one of multi-channel multicasting or unicasting using VoD service channels classified based on a user request rate, in order to provide a greater number of users with a VoD service within a limited system capacity. Furthermore, when multicast transmission is more efficient than unicast transmission for each VoD content, VoD content may be multicast to a client, and thus it is possible to effectively utilize the bandwidth for the VoD broadcast service.

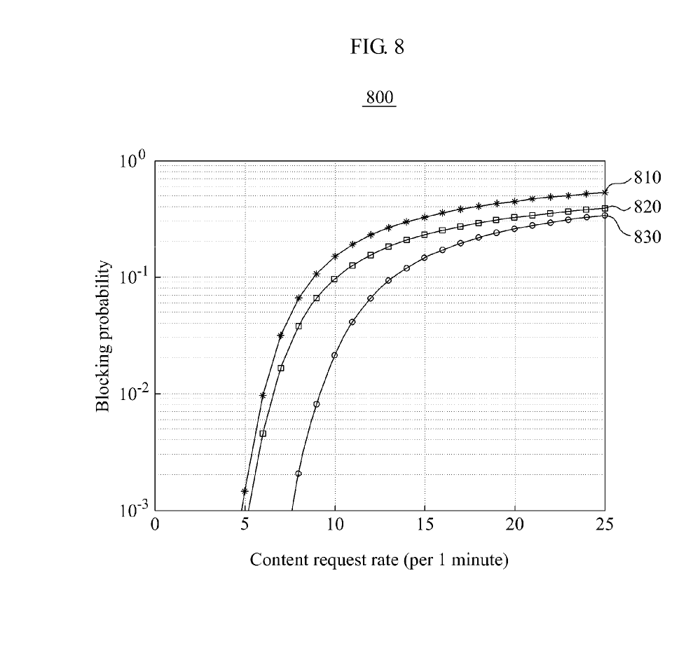

FIG. 8 is a graph 800 illustrating performance of a VoD service system according to an exemplary embodiment of the present invention. In FIG. 8, the graph 800 shows a blocking probability according to a content request rate. In the graph 800, an x-axis represents the number of content requests, namely a content request rate, and a y-axis represents the blocking probability. Additionally, a first curve 810 represents blocking probability obtained when content is provided by unicast only, and a second curve 820 represents blocking probability obtained when content is provided by both unicast and multicast. Furthermore, a third curve 830 represents blocking probability obtained when content is provided by a more efficient method, namely unicast or multicast, selected taking into consideration the MEF as described above for the exemplary embodiments of the present invention. As shown in the graph 800, when the MEF is used, the blocking probability may be reduced over the entire range of content request rates, compared to when the MEF is not used.

The exemplary embodiments of the present invention may be recorded in computer-readable media including program instructions to implement various operations embodied by a computer. The computer-readable media may also include, alone or in combination with the program instructions, data files, data structures, and the like. The program instructions recorded on the media may be those specially designed and constructed for the purposes of the present invention, or they may be of the kind well-known and available to those having skill in the computer software arts. Examples of computer-readable media include magnetic media, such as hard disks, floppy disks, and magnetic tape; optical media such as CD ROM disks and DVD; magneto-optical media, such as optical disks; and hardware devices specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A video-on-demand (VoD) service system, comprising:
a multicast efficiency factor (MEF) checking unit to check an MEF in a content in response to a request for the content from a client; and
a content transmission unit to multicast or unicast the content over a network depending on the checked MEF,
wherein the MEF comprises an indicator of efficiency for multicast transmission relative to unicast transmission of the content.

2. The VoD service system of claim 1, wherein the MEF is determined based on a request rate, a length of a time unit, and a start-up delay time with respect to the content.

3. The VoD service system of claim 1, wherein the content transmission unit comprises:
a multicast unit to multicast the content when the MEF is equal to or greater than a predetermined value; and
a unicast unit to unicast the content when the MEF is less than the predetermined value.

4. The VoD service system of claim 3, wherein the multicast unit comprises:
a content division unit to divide the content into a plurality of segments to implement a multi-channel multicast; and
a transmitter to map the plurality of segments to a multicast classifier and to multicast the content.

5. The VoD service system of claim 4, wherein a number of channels for the multi-channel multicast is determined based on a length of a time unit and a start-up delay time, and
a number of the segments is determined based on the number of channels.

6. The VoD service system of claim 1, further comprising:
a multicasting determination unit to determine whether the content is currently multicast; and
a multicast group address transmitter to transmit a multicast group address to the client when the content is determined to be currently multicast or when the content transmission unit multicasts the content.

7. The VoD service system of claim 1, wherein the MEF checking unit checks the MEF when the content is determined not to be currently multicast.

8. A method for providing a video-on-demand (VoD) service in a VoD service system, the method comprising:
checking a multicast efficiency factor (MEF) in a content in response to a request for the content from a client; and
multicasting or unicasting the content over a network depending on the checked MEF,
wherein the MEF comprises an indicator of efficiency for multicast transmission relative to unicast transmission of the content.

9. The method of claim 8, wherein the MEF is determined based on a request rate, a length of a time unit, and a start-up delay time with respect to the content.

10. The method of claim 8, wherein the multicasting or unicasting of the content comprises:
multicasting the content when the MEF is equal to or greater than a predetermined value; and
unicasting the content when the MEF is less than the predetermined value.

11. The method of claim 8, further comprising:
determining whether the content is currently multicast; and
transmitting a multicast group address to the client when the content is determined to be currently multicast.
